(19) United States
(12) Patent Application Publication
(10) Pub. No.: US 2020/0332112 A1
(43) Pub. Date: Oct. 22, 2020

(54) BIODEGRADABLE FILAMENTS AND USE OF SUCH FILAMENTS

(71) Applicant: Beaulieu International Group NV, Waregem (BE)

(72) Inventors: Laurens Jean-Marc L. GOORMACHTIGH, Waregem (BE); Femke FAELENS, Gent (BE); Frans VAN GIEL, Kortrijk (BE)

(21) Appl. No.: 16/956,189

(22) PCT Filed: Dec. 20, 2018
(86) PCT No.: PCT/EP2018/086302

§ 371 Date: Jun. 19, 2020

(30) Foreign Application Priority Data
Dec. 21, 2017 (EP) 17209302.3

(51) Int. Cl. C08L 67/04; C08L 67/02; C09K 17/18; B29C 48/05; B29C 48/08; D01D 5/42; D01F 6/62; D01F 6/92; B29C 48/00

(52) U.S. Cl. CPC C08L 67/04; C08L 67/02; C09K 17/18; B29C 48/05; B29C 48/08; D01D 5/42; B29K 2067/04; D01F 6/92; B29C 48/0022; C08L 2201/06; C08L 2203/12; C08L 2205/025; D01F 6/625

(57) ABSTRACT

The invention relates to a filament, made from a polymer composition comprising:—at least 40 to at most 90 percent by weight of a first biodegradable polymer; and,—at least 10 to at most 60 percent by weight of a second biodegradable polymer; wherein the percentage by weight is expressed compared to the total weight of the polymer composition; and, wherein the visual degradation speed of the first biodegradable polymer is faster than the visual degradation speed of the second biodegradable polymer when in contact with soil under the same conditions.

### FIELD OF THE INVENTION

The invention relates to biodegradable filaments, and to methods for tuning the speed of degradation of the filaments and of products made from the filaments.

### BACKGROUND OF THE INVENTION

Biodegradable groundcovers currently on the market are often made from natural materials, such as coco mats. However, these natural materials are often lacking mechanical integrity, are often characterized by low tensile strengths, making them unsuitable for some applications, and/or are often too thick and heavy to compensate for the lack of mechanical properties.

Although the use of biodegradable polymers is becoming more and more popular, the uses are being restricted by the properties of the biodegradable polymers, such as tensile strength or the speed of disintegration. Quite often the tensile strength is not sufficient for a certain use or the speed of disintegration is too slow or too fast. For some uses, there is quite a specific demand in terms of tensile strength and in terms of visual disintegration.

There is a demand for a groundcover which can be used in new plantations, to control weed growth between the newly planted plants, which visually disintegrates once the newly planted plants have grown to a certain size so that the plants themselves can suppress the growth of weed. For this use, the desired visual disintegration time is between 3 and 5 years. However, especially in the first years, the groundcover needs to be robust enough in terms of tensile strength, preferably at least 12 cN/tex, to withstand the conditions in the new plantation. Preferably the groundcover has elongation at break of at least 15%.

There is also a demand for a groundcover which can be used to temporarily stop erosion. For example, to stabilize earth works or dunes until the roots of plants that are planted on these earthworks or dunes are strong enough to stabilize them by themselves. At that point the groundcover can disappear. For this use, the desired visual disintegration time is between 2 and 4 years. However, the tensile strength of the groundcover needs to be large enough, to withstand the elements and stop erosion.

It is accordingly one of the objects of the present invention to overcome or ameliorate one or more of the aforementioned disadvantages of the market, or to meet any of the demands that are present in the market. Preferably the invention also provides a groundcover that creates a microclimate for plants. Preferably the invention also provides a groundcover that is light, preferably lighter than groundcovers made of natural materials. Preferably the invention also provides a groundcover that comprises renewable materials. Preferably the invention also provides a groundcover that visually degrades without harm to the environment in outdoor environments. Preferably the invention also provides a groundcover that requires no maintenance after installation and that disappears completely without any intervention. Preferably the invention also provides a groundcover that has a low shrinkage when exposed to elevated temperatures. Preferably the invention also provides a groundcover that has a good water permeability. Preferably the invention also provides a groundcover that has a good burning behaviour (preferably passes ISO 12952-2 and/or ISO 12952-3). For example, the invention also provides a groundcover that is degradable according to the EN 13432 norm. Preferably, the invention provides a groundcover of which the filaments are homogeneous in terms of composition, mechanical properties, and/or biodegradability. Preferably the groundcover can be easily produced. Preferably, the material of the groundcover is compatible with most common colourants, and/or vice versa.

### SUMMARY OF THE INVENTION

The present inventors have now surprisingly found that one or more of these objects can be obtained by altering the polymer composition used to prepare filaments.

According to a first aspect, the invention relates to a filament, made from a polymer composition comprising:
at least 40 to at most 90 percent by weight of a first biodegradable polymer, preferably at least 50 to at most 85 percent by weight of a first biodegradable polymer; and,
at least 10 to at most 60 percent by weight of a second biodegradable polymer, preferably at least 15 to at most 50 percent by weight of a second biodegradable polymer;
   wherein the percentage by weight is expressed compared to the total weight of the polymer composition; and,
   wherein the visual degradation speed of the first biodegradable polymer is faster than the visual degradation speed of the second biodegradable polymer when in contact with soil under the same conditions.

According to a second aspect, the invention also relates to a filament, made from a polymer composition comprising:
at least 40 to at most 90 percent by weight, preferably at least 50 to at most 85 percent by weight of a first biodegradable polymer selected from the group comprising: polycaprolactone (PCL), polybutylene succinate-co-adipate (PBSA), polyhydroxyalkanoate (PHA), and/or mixtures thereof; more preferably polycaprolactone (PCL) and/or polyhydroxyalkanoate (PHA), and/or mixtures thereof; and,
at least 10 to at most 60 percent by weight, preferably at least 15 to at most 50 percent by weight of a second biodegradable polymer selected from the group comprising: polylactic acid (PLA), polybutylene succinate (PBS), polybutyrate (PBAT), and/or mixtures thereof, preferably polylactic acid (PLA);
   wherein the percentage by weight is expressed compared to the total weight of the polymer composition.

According to a third aspect, the invention also relates to a filament, made from a polymer composition comprising:
at least 40 to at most 90 percent by weight of a first biodegradable polymer, preferably at least 50 to at most 85 percent by weight of a first biodegradable polymer; and,
at least 10 to at most 60 percent by weight of a second biodegradable polymer, preferably at least 15 to at most 50 percent by weight of a second biodegradable polymer;
   wherein the percentage by weight is expressed compared to the total weight of the polymer composition; and, wherein:
the visual degradation speed of the first biodegradable polymer is such that at least 80% visual degradation occurs in a period of at most 6 weeks, preferably at most 5 weeks, preferably at most 4 weeks; under conditions according to the modified ISO 20200:2015 norm; and,
the visual degradation speed of the second biodegradable polymer is such that at most 10% visual degradation occurs in a period of at least 25 weeks, preferably at least 30 weeks, more preferably at least 35 weeks, even more preferably 40 weeks, and most preferably at least 42 weeks; under conditions according to the modified ISO 20200:2015 norm.

In some preferred embodiments of the first, second, and third aspect, the visual degradation speed of the first biodegradable polymer is faster than the visual degradation speed of the second biodegradable polymer when in contact with soil under the same conditions. Any test method for the determination of a visual degradation speed can be used to determine the relative visual degradation speed of two biodegradable polymers, as long as for both biodegradable polymers the same conditions are used in the test method. For example the ISO 17556:2012 or EN 17033:2018 could be used for relative visual degradation speeds of two biodegradable polymers. Alternatively, also the modified ISO 20200:2015 norm could be used. In the unlikely event that the results of different test contradict each other, the modified ISO 20200:2015 norm is the preferred method.

In some preferred embodiments of the first, second, and third aspect, the first biodegradable polymer is selected from the group comprising: polycaprolactone (PCL), polybutylene succinate-co-adipate (PBSA), polyhydroxyalkanoate (PHA), and/or mixtures thereof; more preferably polycaprolactone (PCL) and/or polyhydroxyalkanoate (PHA), and/or mixtures thereof.

In some preferred embodiments of the first, second, and third aspect, the second biodegradable polymer is selected from the group comprising: polylactic acid (PLA), polybutylene succinate (PBS), polybutyrate (PBAT), and/or mixtures thereof, preferably polylactic acid (PLA). In some preferred embodiments of the first, second, and third aspect, the polybutylene succinate (PBS) is a homopolymer.

In some preferred embodiments of the first, second, and third aspect, the visual degradation speed of the first biodegradable polymer is such that at least 80% visual degradation occurs in a period of at most 6 weeks, preferably at most 5 weeks, preferably at most 4 weeks; under conditions according to the modified ISO 20200:2015.

In some preferred embodiments of the first, second, and third aspect, the visual degradation speed of the second biodegradable polymer is such that at most 10% visual degradation occurs in a period of at least 25 weeks, preferably at least 30 weeks, more preferably at least 35 weeks, even more preferably 40 weeks, and most preferably at least 42 weeks; under conditions according to the modified ISO 20200:2015.

In some preferred embodiments of the first, second, and third aspect, the polymer composition comprises at least 40 to at most 90 percent by weight polyhydroxyalkanoate (PHA), preferably at least 50 to at most 85 percent by weight, wherein the percentage by weight is expressed compared to the total weight of the polymer composition. In some preferred embodiments of the first, second, and third aspect, the polyhydroxyalkanoate (PHA) is selected from the group comprising: poly-3-hydroxybutyrate (P3HB), poly-4-hydroxybutyrate (P4HB), poly-3-hydroxyvalerate (PHV), poly(3-hydroxybutyrate-co-3-hydroxyvalerate) (PHBV), poly-3-hydroxyhexanoate (PHH) or a copolymer thereof, preferably poly(3-hydroxybutyrate-co-3-hydroxyvalerate) (PHBV) or a copolymer (PH BH) of poly-3-hydroxybutyrate and poly-3-hydroxyhexanoate, most preferably a copolymer (PHBH) of poly-3-hydroxybutyrate and poly-3-hydroxyhexanoate.

In some preferred embodiments of the first, second, and third aspect, the shrinkage of the filament, when placed for 20 seconds in an oil bath at 80° C., is at most 20%, preferably at most 10%, more preferably at most 5%.

In some preferred embodiments of the first, second, and third aspect, the filament has a tensile strength at break of at least 10 cN/tex, preferably of at least 12 cN/tex, more preferably of at least 15 cN/tex, even more preferably of at least 17 cN/tex, and most preferably of at least 20 cN/tex determined according to ISO 2062(2009), using the following parameters: pretension of 0.5 cN/tex; rate of extension 500 mm/min; gauge length 500 mm.

In some preferred embodiments of the first, second, and third aspect, the filament has an elongation at break of at least 10%, preferably of at least 13%, more preferably of at least 15%, even more preferably of at least 17%, and most preferably of at least 20%, determined according to ISO 2062(2009), using the following parameters: pretension of 0.5 cN/tex; rate of extension 500 mm/min; gauge length 500 mm.

In some preferred embodiments of the first, second, and third aspect, the polymer composition comprises a filler, preferably at least 0.1 to at most 5.0 percent by weight, more preferably at least 0.5 to at most 4.0 percent by weight, even more preferably at least 1.0 to at most 3.0 percent by weight, and most preferably at least 2.0 to at most 2.5 percent by weight of a filler; wherein the percentage by weight is expressed compared to the total weight of the polymer composition. The inventors have found that the filler improves the mechanical properties of the filaments and/or weavability of the filaments and/or the processing of the filaments, such as slitting of a film into tapes.

In some preferred embodiments of the first, second and third aspect, the polymer composition comprises chalk or talc, preferably at least 1.0 to at most 5.0 percent by weight, more preferably from 1.5 to 3.0 percent by weight of chalk or talc; wherein the percentage by weight is expressed compared to the total weight of the polymer composition.

According to a fourth aspect, the invention relates to a method for manufacturing a filament, the method comprising the steps of:
blending from at least 40 to at most 90 percent by weight of a first biodegradable polymer with at least 10 to at most 60 percent by weight of a second biodegradable polymer to form a polymer composition, wherein the visual degradation speed of the first biodegradable polymer is faster than the visual degradation speed of the second biodegradable polymer when in contact with soil under the same conditions;
extruding the polymer composition as filaments or as a film; and,
optionally, slitting the film into slit film tapes;
   thereby obtaining a filament.

According to a fifth aspect, the invention relates to a method for manufacturing a filament, the method comprising the steps of:
blending from at least 40 to at most 90 percent by weight of a first biodegradable polymer selected from the group comprising: polycaprolactone (PCL), polybutylene succinate-co-adipate (PBSA) and/or polyhydroxyalkanoate (PHA), and/or mixtures thereof with at least 10 to at most 60 percent by weight of a second biodegradable polymer second biodegradable polymer selected from the group comprising: polylactic acid (PLA), polybutylene succinate (PBS), polybutyrate (PBAT), and/or mixtures thereof, preferably polylactic acid (PLA), to form a polymer composition;
extruding the polymer composition as filaments, or as a film; and,
optionally, slitting the film into slit film tapes; thereby obtaining a filament.

According to a sixth aspect, the invention relates to a method for manufacturing a filament, the method comprising the steps of:
blending from at least 40 to at most 90 percent by weight of a first biodegradable polymer with at least 10 to at most 60 percent by weight of a second biodegradable polymer to form a polymer composition;
extruding the polymer composition as filaments, or as a film; and,
optionally, slitting the film into slit film tapes; thereby obtaining a filament;
   the visual degradation speed of the first biodegradable polymer is such that at least 80% visual degradation occurs in a period of at most 6 weeks, preferably at most 5 weeks, preferably at most 4 weeks; under conditions according to the modified ISO 20200:2015 norm; and,
   wherein the visual degradation speed of the second biodegradable polymer is such that at most 10% visual degradation occurs in a period of at least 25 weeks, preferably at least 30 weeks, more preferably at least 35 weeks, even more preferably 40 weeks, and most preferably at least 42 weeks; under conditions according to the modified ISO 20200:2015 norm.

(Preferred) embodiments of the first, second, or third aspect are also (preferred) embodiments of the fourth, fifth, or sixth aspect and vice versa.

(Preferred) embodiments of one aspect of the invention are also (preferred) embodiments of the other aspects of the invention.

In some preferred embodiments, during the step of extruding the polymer composition, the temperature of the extrusion head is from 150 to 220° C., preferably from 155 to 210° C., more preferably from 160 to 200° C.

According to a seventh aspect, the invention relates to a fabric or a netting comprising filaments according to the first, second or third aspects or embodiments thereof, or filaments manufactured by a method according to the fourth, fifth or sixth aspect or embodiments thereof. The fabric and the netting can be woven or non-woven.

(Preferred) embodiments of the first to sixth aspect are also (preferred) embodiments of the seventh aspect and vice versa.

According to an eighth aspect, the invention relates to a groundcover comprising filaments according to the first, second or third aspects or embodiments thereof, or filaments manufactured by a method according to the fourth, fifth or sixth aspect or embodiments thereof, or a fabric according to the seventh aspect or embodiments thereof. (Preferred) embodiments of the first to seventh aspect are also (preferred) embodiments of the eighth aspect and vice versa.

According to a ninth aspect, the invention relates to the use of a groundcover according to the eighth aspect or embodiments thereof, for temporary weed control, preferably wherein the groundcover has a weight of at least 30 g/m² to at most 500 g/m², preferably at least 50 g/m² to at most 300 g/m², more preferably at least 70 g/m² to at most 200 g/m², even more preferably at least 90 g/m² to at most 150g/m² and most preferably around 110 g/m² and wherein the groundcover has a content of second biodegradable polymer, preferably PLA, of at least 20 to at most 55 percent by weight, preferably at least 25 to at most 50 percent by weight and most preferably at least 30 to at most 45 percent by weight, compared to the total weight of the polymer composition used to make the groundcover.

According to a tenth aspect, the invention relates to the use of a groundcover according to the eighth aspect or embodiments thereof, for temporary erosion control, wherein the groundcover has a weight of at least 50 g/m² to at most 1000 g/m², preferably at least 100 g/m² to at most 800 g/m², more preferably at least 150 g/m² to at most 600 g/m², even more preferably at least 200 g/m² to at most 400 g/m² and most preferably around 300 g/m² and wherein the groundcover has a content of second biodegradable polymer, preferably PLA, of at least 10 to at most 60 percent by weight, preferably at least 15 to at most 50 percent by weight, compared to the total weight of the polymer composition used to make the groundcover.

According to an eleventh aspect, the invention relates to the use of a fabric according to the seventh aspect or embodiments thereof, as temporary packaging material.

According to a twelfth aspect, the invention relates to the use of a netting according to the seventh aspect or embodiments thereof, as temporary protection material.

Preferred embodiments of the invention are disclosed in the detailed description and appended claims. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### BRIEF DESCRIPTION OF THE FIGURES

FIG. 1 shows the results for an accelerated disintegration test as explained herein, for slit film tapes differing in PHA and PLA content.

FIG. 2 shows the results for an accelerated disintegration test as explained herein, for slit film tapes differing in PCL and PLA content.

FIG. 3 shows the results for an accelerated disintegration test as explained herein, for slit film tapes made from the same polymer mixture comprising 75% by weight PCL and 25% by weight PLA, but differing from each other in thickness.

FIG. 4 shows the results for an accelerated disintegration test as explained herein, for slit film tapes differing in PCL and PBS content.

FIG. 5a shows an example of a viscosity vs share rate plot wherein the first and second polymer are incompatible for industrial extrusion processes, as the two curves don't cross in the region from at least 100 s⁻¹ to at most 1000 s⁻¹.

FIG. 5b shows an example of a viscosity vs share rate plot wherein the first and second polymer are compatible for industrial extrusion processes, as the two curves cross in the region from at least 100 s⁻¹ to at most 1000 s⁻¹.

FIG. 6a visually illustrates the inhomogeneous waves during extrusion when a first biodegradable polymer and a second biodegradable polymer are used, of which the plots of the viscosity vs. share rate do not cross in the region from at least 100 s⁻¹ to at most 1000 s⁻¹.

FIG. 6b visually illustrates the homogeneous extrusion when a first biodegradable polymer and a second biodegradable polymer are used, of which the plots of the viscosity vs. share rate do cross in the region from at least 100 s⁻¹ to at most 1000 s⁻¹.

### DETAILED DESCRIPTION OF THE INVENTION

When describing the invention, the terms used are to be construed in accordance with the following definitions, unless a context dictates otherwise.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

As used in the specification and the appended claims, the singular forms “a”, “an,” and “the” include plural referents unless the context clearly dictates otherwise. By way of example, “a filament” means one filament or more than one filament. As used herein, the term “polymer” comprises homopolymers (e.g., prepared from a single monomer species), copolymers (e.g., prepared from at least two monomer species), and graft polymers.

Unless defined otherwise, all technical and scientific terms used herein have the same meaning as is commonly understood by one of skill in the art. All publications referenced herein are incorporated by reference thereto.

Throughout this application, the term ‘about’ is used to indicate that a value includes the standard deviation of error for the device or method being employed to determine the value.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

According to a first aspect, the invention relates to a filament, made from a polymer composition comprising:
at least 40 to at most 90 percent by weight of a first biodegradable polymer, preferably at least 50 to at most 85 percent by weight of a first biodegradable polymer; and,
at least 10 to at most 60 percent by weight of a second biodegradable polymer, preferably at least 15 to at most 50 percent by weight of a second biodegradable polymer;
   wherein the percentage by weight is expressed compared to the total weight of the polymer composition; and,
   wherein the visual degradation speed of the first biodegradable polymer is faster than the visual degradation speed of the second biodegradable polymer when in contact with soil under the same conditions.

According to a second aspect, the invention also relates to a filament, made from a polymer composition comprising:
at least 40 to at most 90 percent by weight, preferably at least 50 to at most 85 percent by weight of a first biodegradable polymer selected from the group comprising: polycaprolactone (PCL), polybutylene succinate-co-adipate (PBSA) and/or polyhydroxyalkanoate (PHA), and/or mixtures thereof; more preferably polycaprolactone (PCL) and/or polyhydroxyalkanoate (PHA), and/or mixtures thereof; and,
at least 10 to at most 60 percent by weight, preferably at least 15 to at most 50 percent by weight of a second biodegradable polymer selected from the group comprising: polylactic acid (PLA), polybutyrate (PBAT), polybutylene succinate (PBS), and/or mixtures thereof, preferably polylactic acid (PLA);
   wherein the percentage by weight is expressed compared to the total weight of the polymer composition.

According to a third aspect, the invention also relates to a filament, made from a polymer composition comprising:
at least 40 to at most 90 percent by weight of a first biodegradable polymer, preferably at least 50 to at most 85 percent by weight of a first biodegradable polymer; and,
at least 10 to at most 60 percent by weight of a second biodegradable polymer, preferably at least 15 to at most 50 percent by weight of a second biodegradable polymer;
   wherein the percentage by weight is expressed compared to the total weight of the polymer composition; and, wherein:
the visual degradation speed of the first biodegradable polymer is such that at least 80% visual degradation occurs in a period of at most 6 weeks, preferably at most 5 weeks, preferably at most 4 weeks; under conditions according to the modified ISO 20200:2015 norm; and,
the visual degradation speed of the second biodegradable polymer is such that at most 10% visual degradation occurs in a period of at least 25 weeks, preferably at least 30 weeks, more preferably at least 35 weeks, even more preferably 40 weeks, and most preferably at least 42 weeks; under conditions according to the modified ISO 20200:2015 norm.

In some preferred embodiments of the first, second and third aspect, the plots of the viscosity of the first biodegradable polymer and the second biodegradable polymer measured according to ISO 11443:2014 at the same temperature, plotted in function of shear rate also measured according to ISO 11443:2014, cross in the shear rate region from at least 100 s⁻¹ to at most 1000 s⁻¹, preferably from at least 200 s⁻¹ to at most 900 s⁻¹, more preferably from at least 300 s⁻¹ to at most 800 s⁻¹, even more preferably from at least 400 s⁻¹ to at most 700 s⁻¹ and most preferably from at least 500 s⁻¹ to at most 600 s⁻¹. Preferably, the plots of the viscosity of the first biodegradable polymer and the second biodegradable polymer measured according to ISO 11443:2014 at the same temperature, plotted in function of shear rate also measured according to ISO 11443:2014, cross in the shear rate region around the expected shear rate of the die, preferably ±10%, more preferably ±5%. Preferably, said same temperature is the temperature during extrusion of the filament and/or the temperature of the extrusion head. It has been found that this results in a homogeneous filament, in terms of composition and in terms of properties, such as mechanical properties and/or biodegradability. Weak spots in the filaments are avoided and/or the filaments do not break easily during stretching. This also provides a good processability of the polymer composition and the filaments, especially during industrial processing.

In some embodiments of the first, second and third aspect, the same temperature is a temperature 10° C. above the Tm of the first biodegradable polymer or the Tm of the second biodegradable polymer; whichever is the highest.

In some embodiments of the first, second and third aspect, transesterification between the first biodegradable polymer and the second biodegradable polymer occurs during extrusion.

In some embodiments of the first, second and third aspect, the first biodegradable polymer is PHA and the second biodegradable polymer is PLA.

In some embodiments of the first, second and third aspect, a nucleating agent is added to the polymer composition. This reduces the stickiness of the filaments to rolls downstream from the extruder.

In some preferred embodiments of the first, second and third aspect, the visual degradation speed of the first biodegradable polymer is faster than the visual degradation speed of the second biodegradable polymer when in contact with soil under the same conditions.

In some preferred embodiments of the first, second and third aspect, the first biodegradable polymer is selected from the group comprising: polycaprolactone (PCL), polybutylene succinate-co-adipate (PBSA) and/or polyhydroxyalkanoate (PHA), and/or mixtures thereof; more preferably polycaprolactone (PCL) and/or polyhydroxyalkanoate (PHA), and/or mixtures thereof.

In some preferred embodiments of the first second and third aspect, the second biodegradable polymer is selected from the group comprising: polylactic acid (PLA), polybutyrate (PBAT), polybutylene succinate (PBS), and/or mixtures thereof, preferably polylactic acid (PLA).

In some preferred embodiments of the first second and third aspect, the visual degradation speed of the first biodegradable polymer is such that at least 80% visual degradation occurs in a period of at most 6 weeks, preferably at most 5 weeks, preferably at most 4 weeks; under conditions according to the modified ISO 20200:2015 norm.

In some preferred embodiments of the first second and third aspect, the visual degradation speed of the second biodegradable polymer is such that at most 10% visual degradation occurs in a period of at least 25 weeks, preferably at least 30 weeks, more preferably at least 35 weeks, even more preferably 40 weeks, and most preferably at least 42 weeks; under conditions according to the modified ISO 20200:2015 norm.

The inventors have surprisingly found that groundcovers made from such filaments and/or (preferred) embodiments thereof visually disintegrate when in contact with soil or compost in a period ranging from 1 to 7 years, typically from 2 years to 6 years, more typically from 3 years to 5 years, depending on the chosen composition. The visual disintegration time can be controlled by the chosen composition of the polymer composition. Such filaments, however, still have high tensile strength, so that these filaments can be used as ground covers for temporary weed control or to stabilize temporary erosion. Such filaments are also suitable for making degradable packages, which can be used to package degradable waste, amongst others.

As used herein, the term “same conditions” preferably refers to identical conditions in terms of temperature, surface percentage of the filament that is in contact with the soil, biological activity in the soil, soil composition, humidity, and light conditions.

As used herein, the term “biodegradable polymer” refers to a polymer fulfilling the requirements of EN 13432:2000.

As used herein, the term “visual disintegration” refers to degradation of a material to the extent that it cannot be seen by the naked eye anymore (100% visual disintegration), preferably disintegration into pieces smaller than 0.10 mm, more preferably smaller than 0.05 mm. Uncomplete visual degradation can be expressed as a percentage of the material that has visually disappeared compared to the material before the disintegration started.

A preferred method to measure the visual degradation test of filaments, fabrics, or groundcovers is the modified ISO EN 20200:2015 norm as explained in the example section. In some embodiments, other test can be used to compare the speed of visual degradation of two biodegradable polymers, such as the unmodified ISO EN 20200:2015 norm, or any test applying the same condition for biodegradable polymers.

Amongst others, OWS nv (organic waste systems), a company in Ghent, Belgium, may be suitable to carry out the modified ISO EN 20200:2015 test.

In some embodiments, the melt flow index (MFI) of the first biodegradable polymer is at least 0.5 g/10 min to at most 50.0 g/10 min, preferably at least 1.0 g/10 min to at most 30.0 g/10 min. In some preferred embodiments of the first, second, and third aspect where the filament is a tape or a slit film tape, the MFI of the first biodegradable polymer is preferably at least 1.0 g/10 min to at most 10.0 g/10min, preferably at least 2.0 g/10 min to at most 7.0 g/10 min. In some alternative preferred embodiments where the filament is a yarn, the MFI of the first biodegradable polymer is preferably at least 10.0 g/10 min to at most 30.0 g/10min, preferably at least 15.0 g/10 min to at most 25.0 g/10 min, according to ISO 1133:2005 at 190° C. under a weight of 2.16 kg.

In some embodiments, the MFI of the second biodegradable polymer is at least 0.5 g/10 min to at most 50.0 g/10 min, preferably at least 1.0 g/10 min to at most 30.0 g/10 min.

In some preferred embodiments of the first, second, and third aspect where the filament is a tape or a slit film tape, the MFI of the second biodegradable polymer is preferably at least 1.0 g/10 min to at most 10.0 g/10min, preferably at least 2.0 g/10 min to at most 7.0 g/10 min. In some alternative preferred embodiments where the filament is a yarn, the MFI of the second biodegradable polymer is preferably at least 10.0 g/10 min to at most 30.0 g/10min, preferably at least 15.0 g/10 min to at most 25.0 g/10 min, according to ISO 1133:2005 at 190° C. under a weight of 2.16 kg.

In some preferred embodiments of the first, second, and third aspect, the ratio of the MFI of the first biodegradable polymer over the MFI of the second biodegradable polymer, at the same temperature, is at least 0.75 to at most 1.33, preferably at least 0.80 to at most 1.25, more preferably at least 0.85 to at most 1.18, even more preferably at least 0.90 to at most 1.11 and most preferably at least 0.95 to at most 1.05.

Polycaprolactone (PCL) is a polymer that is obtained by polymerization of caprolactone, more preferably c-caprolactone. The polymerization is preferably carried out via ring opening polymerization, more preferably anionic ring opening polymerization. The polymerization may be carried out in the presence of an initiator and/or a catalyst. Both suitable initiators and catalyst are known in the art. Examples of suitable initiators are nucleophilic reagents, such as metal amides, alkoxides, phosphines, amines, alcohols, water or organometals, e.g. alkyl lithium, alkyl magnesium bromide, alkyl aluminium, etc.

Examples of suitable catalysts are stannous (II) 2-ethylhexanoate a.k.a. stannous octoate or [Sn(Oct)₂], aluminium tri-isopropoxide, lanthanide isopropoxide. Polycaprolactone comprises structure (I) as repeating motif, the end groups depend on the used initiator and/or catalyst.

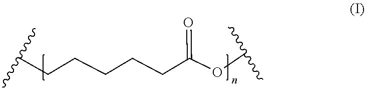

In some embodiments, the weight average molecular weight of the polycaprolactone ranges from at least 100 000 to at most 140 000 g/mol, preferably at least 110 000 to at most 130 000 g/mol, more preferably at least 115 000 g/mol to at most 120 000 g/mol determined by gel permeability chromatography (GPC) in THF at 25° C.

In some embodiments, the melting point of the polycaprolactone ranges from 45 to 70° C., more preferably from 50 to 65° C., even more preferably from 52 to 62° C., and most preferably from 54 to 60° C., determined according to ISO 11357-1 (2016) using a heating rate of 10° C./min.

In some embodiments, the melt flow index (MFI) of the polycaprolactone is at least 0.1 g/10 min to at most 50.0 g/10 min, preferably at least 0.2 g/10 min to at most 30.0 g/10 min, more preferably at least 0.3 g/10 min to at most 10.0 g/10 min, even more preferably at least 0.4 g/10 min to at most 5.0 g/10 min and most preferably at least 0.5 g/10 min to at most 1.0 g/10 min measured according to D 1238, at 80° C. and under a load of 2.16 kg.

It has been found that PCL provides greater strength to the filaments, but also leads to increased shrinkage. Therefore, in some embodiments, the polymer composition comprises a mixture of second biodegradable polymers comprising at most 10 percent by weight PCL, preferably at most 7 percent by weight PCL and most preferably at most 5 percent by weight PCL.

Polyhydroxyalkanoate (PHA) is a polymer that can be classified as a polyester, preferably a linear polyester. Polyhydroxyalkanoate can be produced by bacterial fermentation of lipids and sugar, such as glucose. In some embodiments, the polyhydroxyalkanoate is produced biosynthetically. In some embodiments the polyhydroxyalkanoate is biodegradable.

In some embodiments, the melting point of the polyhydroxyalkanoate is at least 40° C. and at most 180° C., preferably at least 80 ° C. to at most 175° C., more preferably at least 120° C. to at most 170° C. and most preferably at least 140 to at most 150° C., determined according to ISO 11357-1 (2016) using a heating rate of 10° C./min.

In some embodiments, the weight average molecular weight of the polyhydroxyalkanoate is at least 400 000 to at most 700 000 g/mol, preferably at least 450 000 to at most 650 000 g/mol, more preferably at least 500 000 to at most 600 000 g/mol, determined by gel permeability chromatography (GPC) in THF at 25° C. In some embodiments, the melt flow index (MFI) of the PHA is at least 0.1 g/10 min to at most 30.0 g/10 min, preferably at least 0.2 g/10 min to at most 20.0 g/10 min, more preferably at least 0.5 g/10 min to at most 10.0 g/10 min, and most preferably at least 1.0 g/10 min to at most 5.0 g/10 min measured according to D 1238, at 160° C. and under a load of 2.16 kg.

In some embodiments, the polyhydroxyalkanoate (PHA) is selected from the group comprising: poly-3-hydroxybutyrate (P3HB), poly-4-hydroxybutyrate (P4HB), poly-3-hydroxyvalerate (PHV), poly(3-hydroxybutyrate-co-3-hydroxyvalerate) (PHBV), poly-3-hydroxyhexanoate (PHH) or a copolymer thereof, preferably poly(3-hydroxybutyrate-co-3-hydroxyvalerate) (PHBV) or a copolymer (PHBH) of poly-3-hydroxybutyrate and poly-3-hydroxyhexanoate, most preferably a copolymer (PHBH) of poly-3-hydroxybutyrate and poly-3-hydroxyhexanoate.

In some preferred embodiments of the first, second and third aspect, the PHA is a copolymer (PHBH) of poly-3-hydroxybutyrate and poly-3-hydroxyhexanoate comprising at least 1 to at most 15 mole-percent poly-3-hydroxyhexanoate, preferably at least 3 to at most 11 mole-percent poly-3-hydroxyhexanoate, and most preferably at least 4 to at most 7 mole-percent poly-3-hydroxyhexanoate.

Poly(lactic acid) or polylactic acid or polylactide (PLA) is a biodegradable and bioactive thermoplastic aliphatic polyester typically derived from renewable resources, such as corn starch, tapioca roots, chips, starch, sugar beet, cellulose, or sugarcane. There are several routes to usable (i.e. high molecular weight) PLA known in the art. Two main monomers are used: lactic acid, and the cyclic di-ester, lactide. The most common route to PLA is the ring-opening polymerization of lactide with various metal catalysts (typically tin octoate) in solution, in the melt, or as a suspension.

Another route to PLA is the direct condensation of lactic acid monomers. This process needs to be carried out at less than 200° C.; above that temperature, the entropically favoured lactide monomer is generated. This reaction generates one equivalent of water for every condensation (esterification) step, which may be undesirable because water causes chain-transfer leading to low molecular weight material. The direct condensation is thus preferably performed in a stepwise fashion, where lactic acid is first oligomerised to PLA oligomers. Thereafter, polycondensation is done in the melt or as a solution, where short oligomeric units are combined to give a high molecular weight polymer strand.

Polymerization of a racemic mixture of L- and D-lactides usually leads to the synthesis of poly-DL-lactide (PDLLA), which is amorphous. Use of stereospecific catalysts can lead to heterotactic PLA which has been found to show crystallinity. The degree of crystallinity, and hence many important properties, is largely controlled by the ratio of D to L enantiomers used, and to a lesser extent on the type of catalyst used. Apart from chemical polymerisation of lactic acid or lactide, the direct biosynthesis of PLA similar to the poly(hydroxyalkanoate)s is possible as well.

In some embodiments the PLA comprises PLLA (poly-L-lactide), PDLA (poly-D-lactide) or a mixture thereof, preferably PLLA.

In some preferred embodiments of the first, second, and third aspect, the L-content in the PLLA is at least 90% by weight, preferably at least 95% by weight and more preferably at least 98% by weight, determined by NMR.

In some embodiments, the melt flow index (MFI) of the PLA is at least 0.5 g/10 min to at most 30g/10 min, preferably at least 1 g/10 min to at most 20 g/10 min, more preferably at least 3 g/10 min to at most 10.0 g/10 min, and most preferably at least 4 g/10 min to at most 7 g/10 min measured according to D 1238, at 210° C. and under a load of 2.16 kg. Polybutylene succinate (PBS) is a polymer that can be classified as a polyester, more preferably an aliphatic polyester, and most preferably a biodegradable aliphatic polyester. Polybutylene succinate comprises of repeating units of butylene succinate and can be represented by structure (II):

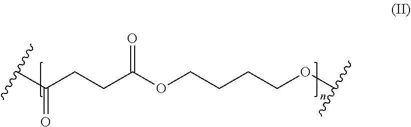

Many ways of producing polybutylene succinate are known in the art. One of them involves the esterification of succinic acid with 1,4-butanediol with the elimination of water, to form oligomers, which is followed by a trans-esterification under vacuum in the presence of a catalyst such as titanium, zirconium, tin or germanium derivatives, to provide high molecular mass polymer.

In some embodiments, the melting point of the polybutylene succinate ranges from 100 to 140° C., more preferably from 105 to 130° C., even more preferably from 110 to 125° C., and most preferably from 110 to 120° C., determined according to ISO 11357-1 (2016) using a heating rate of 10° C/min.

In some embodiments, the melt flow index (MFI) of the PBS is at least 0.1 g/10 min to at most 30.0 g/10 min, preferably at least 0.5 g/10 min to at most 20.0 g/10 min, more preferably at least 0.8 g/10 min to at most 10.0 g/10 min and most preferably at least 1.0 g/10 min to at most 5.0 g/10 min measured according to D 1238, at 190° C. and under a load of 2.16 kg.

Poly(butylene succinate-co-adipate) (PBSA) is a copolymer that can be classified as a polyester, more preferably an aliphatic polyester, and most preferably a biodegradable aliphatic polyester. Poly (butylene succinate-co-adipate) is a copolymer that comprises of repeating units of butylene succinate and butylene adipate and can be represented by structure (III):

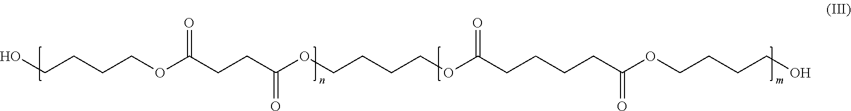

In some embodiments, the melt flow index (MFI) of the PBSA is at least 0.1 g/10 min to at most 30 g/10 min, preferably at least 0.5 g/10 min to at most 20.0 g/10 min, more preferably at least 0.8 g/10 min to at most 10.0 g/10 min and most preferably at least 1 g/10 min to at most 5 g/10 min measured according to D 1238, at 190° C. and under a load of 2.16 kg.

In some embodiments, the monomer units making up the PBSA comprise at least 1 to at most 15 mol % adipate, more preferably at least 3 to at most 10 mol % adipate, even more preferably at least 4 to at most 7 mol % adipate, and most preferably around 5 mol % adipate. It has been found that PBSA provides elasticity and softness to the filaments.

In some embodiments, the melting point of the PBSA ranges from 50 to 120° C., more preferably from 60 to 110° C., even more preferably from 70 to 100° C., and most preferably from 80 to 90° C., determined according to ISO 3146 (2000).

Polybutyrate adipate terephthalate (PBAT), also known as polybutyrate, is a biodegradable random copolymer, specifically a co-polyester of adipic acid, 1,4-butanediol and dimethyl terephthalate as represented in structure (III).

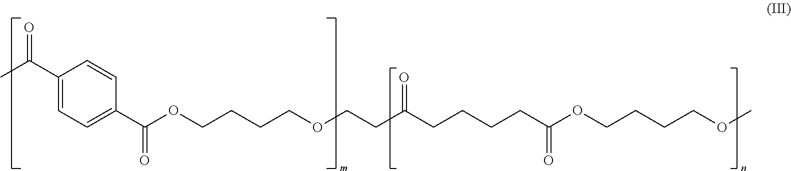

In some embodiments, the ratio between the amount moles of adipic acid over the amount of moles of dimethyl terephthalate in the PBAT is at least 0.1 at most 10.

In some embodiments, the melt flow index (MFI) of the PBAT is at least 0.1 g/10 min to at most 30.0 g/10 min, preferably at least 0.5 g/10 min to at most 20.0 g/10 min, more preferably at least 1.0 g/10 min to at most 10.0 g/10 min, even more preferably at least 2.0 g/10 min to at most 7.0 g/10 min and most preferably at least 2.5 g/10 min to at most 5.0 g/10 min measured according to ISO 1133:2005, at 190° C. and under a load of 2.16 kg.

In some embodiments, the filament is a slit film tape, a fibre, or a yarn, preferably a slit film tape or a fibre, more preferably a slit film tape. The term “slit film tape” refers to a filament that is made by cutting a film into tapes. In some embodiments, the film is stretched before it is slit into tapes. In some alternative embodiments, the slit film tapes are stretched after they have been slit from the film. Stretching the tape increases the tensile strength of the tape. The term “raffia” is a synonym for slit film tape.

The term “fibre” refers to a single strand of untwisted elongated material, fibres include staple fibres and short cut fibres. “Staple fibres” are fibres of limited length, e.g. 20 to 120 mm or up to 300 mm. “Short-cut fibres” are cut fibres of a length from 2 to 25 mm and are generally not crimped.

The term “yarn” can refer to two or more fibres that are interlocked, spun, or twisted and form one filament. A continuous thread is also considered a yarn. Yarns include multi-filaments, monofilaments, continuous filaments, bulked continuous filaments, spun yarn, partially oriented yarn and fully drawn yarn.

In some embodiments, the filament has a tensile strength at break of at least 10 cN/tex, preferably of at least 12 cN/tex, more preferably of at least 15 cN/tex, even more preferably of at least 17 cN/tex, and most preferably of at least 20 cN/tex, determined according to ISO 2062(2009), using the following parameters: pretension of 0,5 cN/tex; rate of extension 500 mm/min; gauge length 500 mm.

In some embodiments, the filament has a tensile strength at break of at least 10 cN/tex to at most 100 cN/tex, preferably of at least 12 cN/tex to at most 90 cN/tex, more preferably of at least 15 cN/tex to at most 80 cN/tex, even more preferably of at least 17 cN/tex to at most 70 cN/tex, and most preferably of at least 20 cN/tex to at most 60 cN/tex, determined according to ISO 2062(2009), using the following parameters: pretension of 0,5 cN/tex; rate of extension 500 mm/min; gauge length 500 mm.

In some embodiments, the filament has an elongation at break of at least 10%, preferably of at least 13%, more preferably of at least 15%, even more preferably of at least 17%, and most preferably of at least 20%, determined according to ISO 2062(2009), using the following parameters: pretension of 0.5 cN/tex; rate of extension 500 mm/min; gauge length 500 mm.

In some embodiments, the thickness or the diameter of the filament is at least 10 μm to at most 300 μm, preferably at least 15 μm to at most 200 μm, more preferably at least 20 μm to at most 150 μm, even more preferably at least 25 μm to at most 100 μm, and most preferably at least 30 μm to at most 50 μm, for example 35 μm.

In some embodiments, the thickness of the filament, preferably a slit film tape, is at least 30 μm to at most 50 μm when the filament is made from a polymer composition comprising at least 20% by weight to at most 50% by weight of the second biodegradable polymer, preferably PLA. Preferably, the polymer composition comprises at least 50% by weight to at most 80% by weight of the first biodegradable polymer, preferably PHA or PBSA, more preferably PHA. Such filaments are ideally suitable to be made in to a groundcover to provide temporary weed control. Preferably the ground cover visually decomposes in 3 to 5 years when in contact with soil exposed to the in a Cfb-climate.

In some embodiments, the thickness of the filament, preferably a slit film tape, is at least 30 μm to at most 50 μm when the filament is made from a polymer composition comprising from 10% by weight to 30% by weight of the second biodegradable polymer, preferably PLA. Preferably, the polymer composition comprises at least 70% by weight to at most 90% by weight of the first biodegradable polymer, preferably PHA or PBSA, more preferably PHA. Such filaments are ideally suitable to be made in to a groundcover to provide temporary erosion control. Preferably the ground cover visually decomposes in 2 to 4 years when in contact with soil exposed to the in a Cfb-climate.

In some embodiments, the linear density of the filament, preferably fibres or yarns, is at least 1 dtex to at most 300 dtex when the filament is made from a polymer composition comprising from 10% by weight to 40% by weight of the second biodegradable polymer, preferably PLA. Preferably, does the polymer composition comprise at least 60% by weight to at most 90% by weight of the first biodegradable polymer, preferably PHA or PBSA, more preferably PHA. Such filaments are ideally suitable to be made in to a hygienic articles or parts thereof. Preferably the hygienic article visually decomposes in 1 to 2 years when in contact with soil exposed to the in a Cfb-climate.

As used herein, the term “hygienic article” includes amongst others: diapers, feminine care articles, and wipes.

In some embodiments, the linear density of the filament, preferably a yarn, is at least 1 dtex to at most 7000 dtex when the yarn is made from a polymer composition comprising from 20% by weight to 50% by weight of the second biodegradable polymer, preferably PLA. Preferably, the polymer composition comprises at least 50% by weight to at most 80% by weight of the first biodegradable polymer, preferably PHA or PBSA, more preferably PHA. Such yarns are ideally suitable to be made in to a woven groundcover, to provide temporary weed control. Preferably the ground cover visually decomposes in 3 to 5 years when in contact with soil exposed to the in a Cfb-climate.

In some embodiments, the linear density of the filament, preferably a yarn, is at least 1 dtex to at most 9000 dtex when the yarn is made from a polymer composition comprising from 20% by weight to 50% by weight of the second biodegradable polymer, preferably PLA. Preferably, the polymer composition comprises at least 50% by weight to at most 80% by weight of the first biodegradable polymer, preferably PHA or PBSA, more preferably PHA. Such yarns are ideally suitable to be made in to a woven groundcover, to provide temporary erosion control. Preferably the ground cover visually decomposes in 2 to 4 years when in contact with soil or compost.

In some embodiments, the polymer composition comprises a filler, preferably at least 0.1 to at most 10.0 percent by weight, more preferably at least 0.5 to at most 7.0 percent by weight, even more preferably at least 1.0 to at most 5.0 percent by weight, and most preferably at least 2.0 to at most 3.0 percent by weight of the filler; wherein the percentage by weight is expressed compared to the total weight of the polymer composition.

In some embodiments, the polymer composition comprises a filler, preferably wherein the filler is selected from the group comprising: chalk; silica, such as precipitated silicas; clay; mica; dolomite; talc; zinc borate; magnesium carbonate; calcium oxide; calcium carbonate; calcium silicate; sodium aluminium silicate; calcium metasilicate; titanium dioxide; diatomaceous earth, barium sulphate, cork, wood-dust, wood-fibre, bamboo, lignin, desiccators, and/or algae and derivatives thereof; more preferably the filler is chalk and/or talc, most preferably chalk.

The quality of pigments and their dispersion in the melt, can be gauged by filter pressure value test (FPV), according to EN 13900-5:2005 using filter screen-pack 3.

In some embodiments, the FPV is at most 30 bar/g, preferably at most 20 bar/g, more preferably at most 15 bar/g, even more preferably at most 10 bar/g, and most preferably at most 5 bar/g. Especially when the filament is a yarn, the FPV value of the filler may be at most 10 bar/g, more preferably at most 1 bar/g. When the filament is a slit film tape, the average particle size of the filler may be at most 30 bar/g, preferably at most 20 bar/g, more preferably at most 15 bar/g, even more preferably at most 10 bar/g, and most preferably at most 5 bar/g.

In some embodiments, the polymer composition comprises chalk, preferably wherein the polymer composition comprises at least 1.0 to at most 5.0 percent by weight, more preferably from 1.5 to 3.0 percent by weight of chalk; wherein the percentage by weight is expressed compared to the total weight of the polymer composition. Especially the use of chalk as a filler helps to prevent splitting of the filament during handling, e.g. weaving.

In some embodiments, the polymer composition comprises at least one colorant. In some embodiments, the polymer composition comprises an additive, for example selected from the group comprising: pigments and pigment pastes, dyes, stabilizers, anti-oxidants, bactericides, fungicides, algaecides, insecticides, rheological modifiers, UV-absorbers, waxes, mineral oils, flame retardants, diluents, elastomers, plasticizers, absorbents, reinforcing agents, odorants, corrosion inhibitors, and combinations thereof.

According to a fourth aspect, the invention relates to a method for manufacturing a filament, the method comprising the steps of:
blending from at least 40 to at most 90 percent by weight of a first biodegradable polymer with at least 10 to at most 60 percent by weight of a second biodegradable polymer to form a polymer composition, wherein the visual degradation speed of the first biodegradable polymer is faster than the visual degradation speed of the second biodegradable polymer when in contact with soil under the same conditions;
extruding the polymer composition as filaments or as a film; and,
optionally, slitting the film into slit film tapes
   thereby obtaining a filament.

According to a fifth aspect, the invention relates to a method for manufacturing a filament, the method comprising the steps of:
blending from at least 40 to at most 90 percent by weight of a first biodegradable polymer selected from the group comprising: polycaprolactone (PCL), polybutylene succinate-co-adipate (PBSA) and/or polyhydroxyalkanoate (PHA), and/or mixtures thereof with at least 10 to at most 60 percent by weight of a second biodegradable polymer second biodegradable polymer selected from the group comprising: polylactic acid (PLA), polybutyrate (PBAT), polybutylene succinate (PBS), and/or mixtures thereof, preferably polylactic acid (PLA), to form a polymer composition;
extruding the polymer composition as filaments or as a film; and,
optionally, slitting the film into slit film tapes;
   thereby obtaining a filament.

According to a sixth aspect, the invention relates to a method for manufacturing a filament, the method comprising the steps of:
blending from at least 40 to at most 90 percent by weight of a first biodegradable polymer with at least 10 to at most 60 percent by weight of a second biodegradable polymer to form a polymer composition;
extruding the polymer composition as filaments or as a film; and,
optionally, slitting the film into slit film tapes thereby obtaining a filament;
   the visual degradation speed of the first biodegradable polymer is such that at least 80% visual degradation occurs in a period of at most 6 weeks, preferably at most 5 weeks, preferably at most 4 weeks; under conditions according to the modified ISO 20200:2015 norm; and,
   wherein the visual degradation speed of the second biodegradable polymer is such that at most 10% visual degradation occurs in a period of at least 25 weeks, preferably at least 30 weeks, more preferably at least 35 weeks, even more preferably 40 weeks, and most preferably at least 42 weeks; under conditions according to ISO 20200:201.

In some embodiments, at most 40 percent by weight PBS is present in the polymer composition, preferably at most 35 percent by weight PBS, more preferably at most 30 percent by weight PBS, even more preferably at most 25 percent by weight PBS and most preferably at most 20 percent by weight PBS. In some embodiments, at most 40 percent by weigh PBAT is present in the polymer composition, preferably at most 35 percent by weight PBAT, more preferably at most 30 percent by weight PBAT, even more preferably at most 25 percent by weight PBAT and most preferably at most 20 percent by weight PBAT.

In some embodiments, during the step of extruding the polymer composition, the temperature of the extrusion head is from 150 to 220° C., preferably from 155° C. to 210° C., more preferably from 160° C. to 200° C., most preferably the temperature of the extrusion head is about 165° C. when the polymer composition comprises more than 20% PHA, In some embodiments, during the step of extruding the polymer composition, the temperature of the extrusion head is from 160 to 240° C., preferably from 175 to 220° C., more preferably from 190 to 210° C., most preferably the temperature of the extrusion head is about 190° C. when the polymer composition comprises more than 20% PCL.

In some embodiments, the polymer blend is extruded as a film, and the step of dividing the extruded polymer composition is performed by slitting.

In some embodiments, the polymer blend is extruded as a film. The film can be either a blown film or a cast film. Film production is easier with processed material having high melt strength.

In some embodiments, orientation of the film or of the cut tapes is carried out by stretching while passing through a hot air oven, infra-red (IR) oven or over a hot plate, maintained at a certain temperature. Preferably the temperature is from 45 to 90° C., more preferably from 50 to 85° C., even more preferably from 55 to 80° C., and most preferably from 60 to 75° C., when the polymer composition comprises at least 30% to at most 70% by weight polycaprolactone (PCL). Preferably the temperature is from 40 to 75° C., more preferably from 45 to 70° C., even more preferably from 50 to 65° C., and most preferably from 55 to 60° C., when the polymer composition comprises at least 71% by weight polycaprolactone (PCL).

Preferably the temperature is from 70 to 140° C., more preferably from 80 to 130° C., even more preferably from 90 to 120° C., and most preferably from 100 to 115° C., for example 105° C. when the polymer composition comprises more than 20% polyhydroxyalkanoate (PHA) or more than 30% polylactic acid (PLA).

Preferably, the oven temperature is from 5 to 70° C., preferably from 10 to 50° C., more preferably from 15 to 30° C. lower than the melting temperature of the polymer composition.

Preferably, the stretched slit film tapes are annealed immediately after the stretching operation in order to minimize shrinkage that could occur as a result of residual stresses in the stretched tapes.

Preferably, a spin finish may be applied to the filaments, more preferably the spin finish is biodegradable and/or non-toxic. An example of a suitable spin finish is DURON OF 2173 sold by CHT group.

Preferably, the filaments are wound on bobbins.

Preferably the slit film tapes are woven into a tissue or a fabric.

Preferably the filaments according to any one of the embodiments of the first aspect of the invention are manufactured according to a method according to any one of the embodiments of the second aspect of the invention

According to a seventh aspect, the invention relates to fabric or a netting comprising filaments according to the first, second or third aspects or embodiments thereof, or filaments manufactured by a method according to the fourth, fifth or sixth aspect or embodiments thereof, preferably wherein the fabric or the netting is a woven fabric or netting.

In some embodiments, the woven fabric has a tensile strength at break in the warp direction of at least 4.0 kN/m, preferably of at least 5.0 kN/m, more preferably of at least 6.0 kN/m, even more preferably of at least 7.0 kN/m, and most preferably of at least 8.0 kN/m, determined according to ISO 10319(2015).

In some embodiments, the woven fabric has a tensile strength at break in the weft direction of at least 1.0 kN/m, preferably of at least 2.0 kN/m, more preferably of at least 3.0 kN/m, even more preferably of at least 4.0 kN/m, and most preferably of at least 4.5 kN/m, determined according to ISO 10319(2015).

In some embodiments, the woven fabric has a elongation at break in the warp direction of at least 10%, preferably of at least 15%, more preferably of at least 20%, even more preferably of at least 25%, and most preferably of at least 30%, determined according to ISO 10319(2015).

In some embodiments, the woven groundcover has a elongation at break in the weft direction of at least 5%, preferably of at least 10%, more preferably of at least 15%, even more preferably of at least 17%, and most preferably of at least 20%, determined according to ISO 10319(2015).

According to an eighth aspect, the invention relates to a groundcover comprising filaments according to the first, second or third aspects or embodiments thereof, or filaments manufactured by a method according to the fourth, fifth or sixth aspect or embodiments thereof, or a fabric according to the seventh aspect or embodiments thereof.

According to a ninth aspect, the invention relates to the use of a groundcover according to the eighth aspect or embodiments thereof, for temporary weed control, preferably wherein the groundcover has a weight of at least 30 g/m² to at most 500 g/m², preferably at least 50 g/m² to at most 300 g/m², more preferably at least 70 g/m² to at most 200 g/m², even more preferably at least 90 g/m² to at most 150g/m² and most preferably around 110 g/m² and wherein the groundcover has a content of second biodegradable polymer, preferably PLA, of at least 20 to at most 50 percent by weight, preferably at least 25 to at most 50 percent by weight and most preferably at least 30 to at most 45 percent by weight, compared to the total weight of the polymer composition used to make the groundcover.

According to a tenth aspect, the invention relates to the use of a groundcover according to the eighth aspect or embodiments thereof, for temporary erosion control, wherein the groundcover has a weight of at least 50 g/m² to at most 1000 g/m², preferably at least 100 g/m² to at most 800 g/m², more preferably at least 150 g/m² to at most 600 g/m², even more preferably at least 200 g/m² to at most 400 g/m² and most preferably around 300 g/m² and wherein the groundcover has a content of second biodegradable polymer, preferably PLA, of at least 10 to at most 35 percent by weight compared to the total weight of the polymer composition used to make the groundcover.

According to an eleventh aspect, the invention relates to the use of a fabric according to the seventh aspect or embodiments thereof, as temporary packaging material. As used herein, the term “temporary packaging material” includes amongst others, degradable bags, protective bags or covers (e.g. for hydrocultivation, protection of grape bunches or other fruit/vegetable), body bags, teabags or coffee pads.

According to a twelfth aspect, the invention relates to the use of a netting according to the seventh aspect or embodiments thereof, as temporary protection material. For example, such netting can be used to protect new plantation, such as new grass, allowing the plants to grow through the netting yet being protected during the early growth period.

The invention will be more readily understood by reference to the following examples, which are included merely for purpose of illustration of certain aspects and embodiments of the present invention and are not intended to limit the invention.

### EXAMPLES

Unless otherwise indicated, all parts and all percentages in the following examples, as well as throughout the specification, are parts by weight or percentages by weight respectively.

### Accelerated Visual Disintegration Test

A test that can be used to compare the visual disintegration of filaments or groundcovers is the ISO 20200:2015 International Standard. However, the test used in the examples differs from ISO 20200:2015 in that the test itself is carried out at 28° C., and the filaments are completely covered on both sides with compost.

The compost is made from fresh vegetables, fruit and garden waste. The composting lasted for 12 weeks at a temperature 58±2° C. (industrial composting conditions). After 12 weeks, the compost is sieved and the fraction <10 mm is used. At the beginning of the test, a mixture of 80% by weight of said compost and 20% fresh vegetable and fruit waste from a restaurant is prepared, which is used in the two testing boxes, to duplicate the results. Tapes are suspended in slide mount frames and placed in the box completely covered with the mixture. The tapes/slide frames are not being dried or moistened before they enter the boxes. The slide frames are dug out and reburied in the same compost every 2 weeks. During the test, the temperature is maintained at 28±2° C. Moisture content of the mixture is maintained between 40 and 60% by weight. Humidity of compost material can be assessed by the “fist-test” (Bundersgutegemeischaft Kompost e.V. (FCQAO), Methods Book 2002).

Using these test conditions, the acceleration factor is estimated at approximately 6, meaning that the when the filaments of the invention are used on the surface of soil exposed to the elements in a Cfb-climate, such as Belgium, the visual disintegration will be approximately 6 times slower. Hence, 26 weeks in the accelerated visual disintegration test corresponds to approximately 3 years under Cfb-climate conditions, wherein the filaments are in touch with soil/compost at only one side.

### Example 1

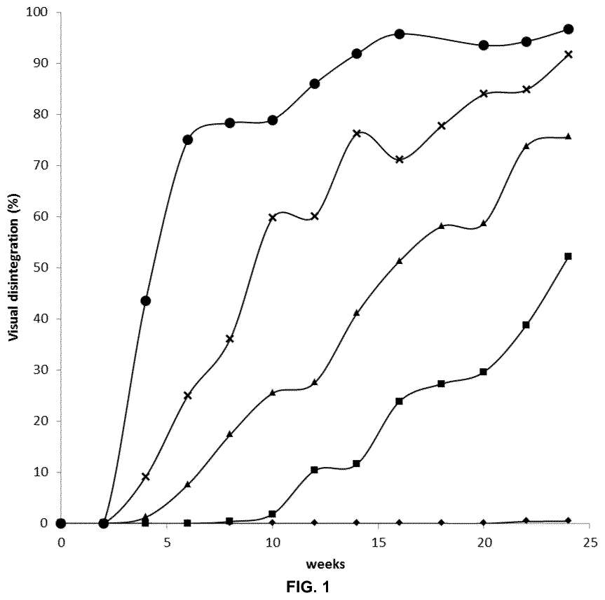

FIG. 1 shows the results for an accelerated disintegration test as explained above, for slit film tapes differing in PHA and PLA content.

The following slit films tapes were tested, all having a thickness between 30 and 40 μm, the symbols serve as a legend to understand FIG. 1:

[symbol] tape made from mixture comprising 50% by weight PHA and 50% by weight PLA;

[symbol] tape made from mixture comprising 60% by weight PHA and 40% by weight PLA;

[symbol] tape made from mixture comprising 70% by weight PHA and 30% by weight PLA;

[symbol] tape made from mixture comprising 80% by weight PHA and 20% by weight PLA;

[symbol] tape made from mixture comprising 90% by weight PHA and 10% by weight PLA.

The PHA used in this example was H1009-H purchased from Danimer Scientific. The PLA used in this example was Natureworks™ Biopolymer 4032D purchased from Ingeo.

TABLE 1
properties of PHA/PLA slit film tapes

| | PHA/PLA | PHA/PLA | PHA/PLA | PHA/PLA | PHA/PLA |
|---|---|---|---|---|---|
| | 50/50 | 60/40 | 70/30 | 80/20 | 90/10 |
| Thickness | 30-40 | 33 | 32 | 33 | 34.5 |
| (μm) | | | | | |
| Width (mm) | — | 2.25 | 2.20 | 2.20 | 2.25 |
| Tex | — | 90 | 86 | 89 | 92.8 |
| (g/1000 m) | | | | | |
| Tensile | — | 14.48 | 12.51 | 12.83 | 11.93 |
| strength | | | | | |
| (cN/tex) | | | | | |
| Elongation | — | 19.34 | 15.88 | 18.67 | 21.33 |
| (%) | | | | | |
| E-modulus 1- | — | 123.40 | 122.60 | 130.00 | 129.75 |
| 5% (cN/tex) | | | | | |
| Tensile | — | 4.17 | 3.89 | 3.51 | 3.22 |
| strength at | | | | | |
| 1% (cN/tex) | | | | | |
| Tensile | — | 8.39 | 8.01 | 7.51 | 6.94 |
| strength at | | | | | |
| 3% (cN/tex) | | | | | |
| Shrinkage | — | 13.70 | 14.00 | 20.00 | 17.50 |
| (%) | | | | | |

### Example 2

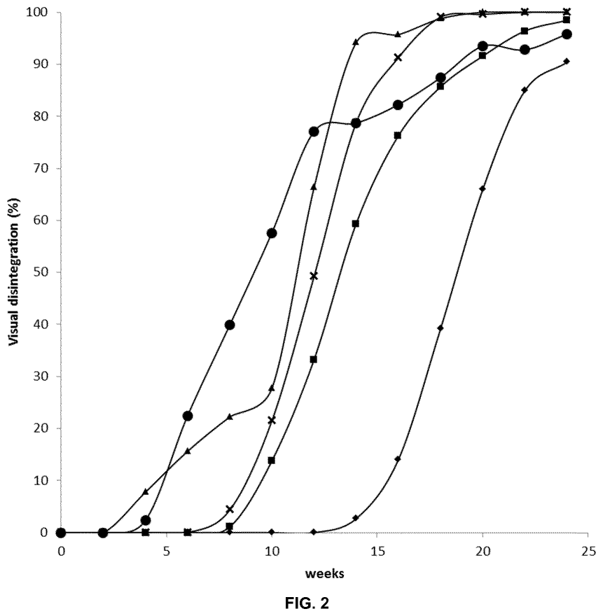

FIG. 2 shows the results for an accelerated disintegration test as explained above, for slit film tapes differing in PCL and PLA content.

The following slit films tapes were tested, all having a thickness between 30 and 40 μm, the symbols serve as a legend to understand FIG. 2:

[symbol] tape made from mixture comprising 50% by weight PCL and 50% by weight PLA;

[symbol] tape made from mixture comprising 60% by weight PCL and 40% by weight PLA;

[symbol] tape made from mixture comprising 75% by weight PCL and 25% by weight PLA;

[symbol] tape made from mixture comprising 80% by weight PCL and 20% by weight PLA;

[symbol] tape made from mixture comprising 90% by weight PCL and 10% by weight PLA.

The PLA used in this example was Natureworks™ Biopolymer 4032D, purchased from Ingeo. The PCL used in this example is Capa™ 6800, purchased from Perstorp.

| | PCL/PLA | PCL/PLA | PCL/PLA | PCL/PLA | PCL/PLA |
|---|---|---|---|---|---|
| | 50/50 | 60/40 | 75/25 | 80/20 | 90/10 |
| Thickness | 32 | 38 | 27 | 31 | 31 |
| (μm) | | | | | |
| Width (mm) | 2.30 | 2.70 | 2.40 | 2.50 | 2.95 |
| Tex | 88.0 | 121.9 | 76.0 | 90.0 | 106.0 |
| (g/1000 m) | | | | | |
| Tensile | 7.09 | 13.20 | 3.20 | 6.87 | 27.26 |
| strength | | | | | |
| (cN/tex) | | | | | |
| Elongation | 7.38 | 51.10 | 28.90 | 41.67 | 22.06 |
| (%) | | | | | |
| E-modulus | 90.33 | 84.70 | 30.10 | 54.17 | 145.20 |
| 1-5% | | | | | |
| (cN/tex) | | | | | |
| Tensile | 3.38 | 3.14 | 1.40 | 1.94 | 1.96 |
| strength at | | | | | |
| 1% (cN/tex) | | | | | |
| Tensile | 6.42 | 6.66 | 2.36 | 3.85 | 5.37 |
| strength at | | | | | |
| 3% (cN/tex) | | | | | |
| Shrinkage | — | — | — | — | 10.7 |
| (%) | | | | | |

### Example 3

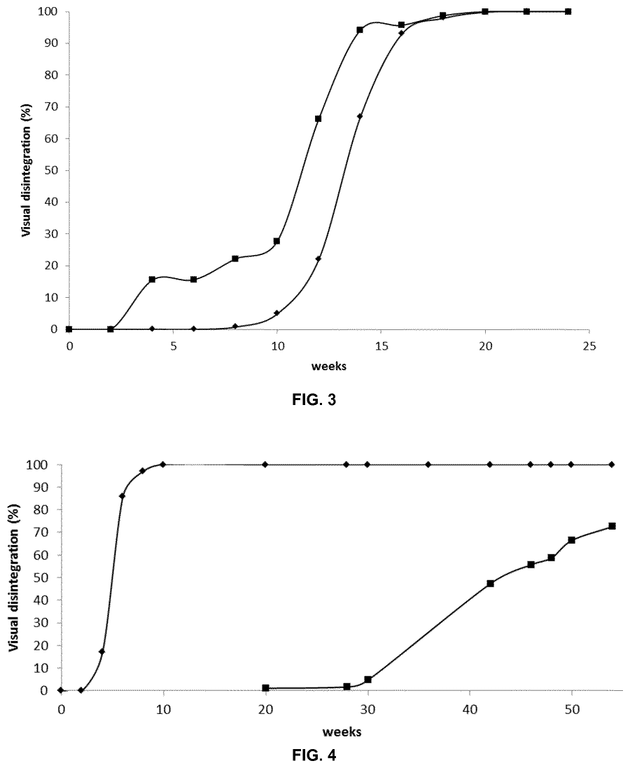

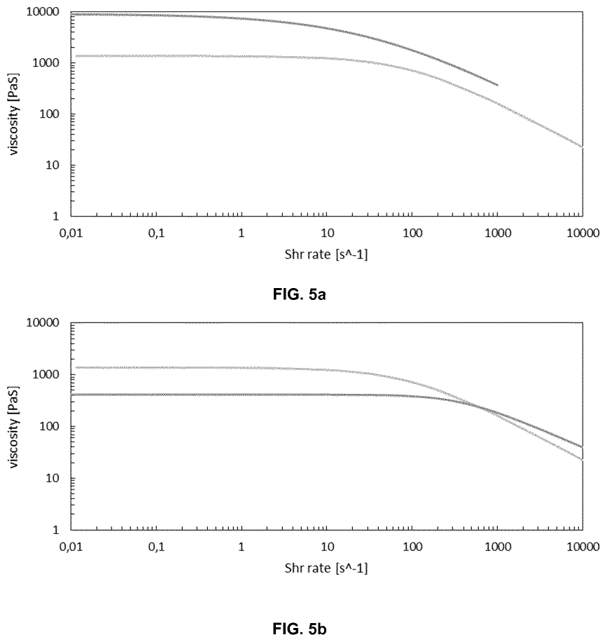

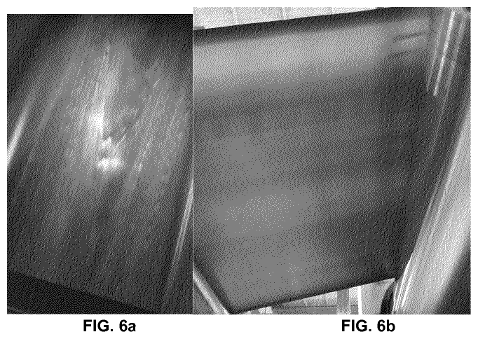

FIG. 3 shows the results for an accelerated disintegration test as explained above, for slit film tapes made from the same polymer mixture comprising 75% by weight PCL and 25% by weight PLA, but differing from each other in thickness.

The following slit films tapes were tested, the symbols serve as a legend to understand FIG. 3:

[symbol] tape with a thickness of 52 μm;

[symbol] tape with a thickness of 27 μm.

The PLA used in this example was Natureworks™ Biopolymer 4032D, purchased from Ingeo. The PCL used in this example is Capa™ 6800, purchased from Perstorp

| | PCL/PLA 75/25 | PCL/PLA 75/25 |
|---|---|---|
| Thickness (μm) | 52 | 27 |
| Width (mm) | 3.15 | 2.40 |
| Tex (g/1000 m) | 193 | 76 |
| Tensile strength | 2.12 | 3.20 |
| (cN/tex) | | |
| Elongation (%) | 43.0 | 28.9 |
| E-modulus 1-5% | 16.07 | 30.10 |
| (cN/tex) | | |
| Tensile strength at | 1.36 | 1.40 |
| 1% (cN/tex) | | |
| Tensile strength at | 6.66 | 2.36 |
| 3% (cN/tex) | | |

### Example 4

FIG. 4 shows the results for an accelerated disintegration test as explained above, for slit film tapes differing in PCL and PBS content.

The following slit films tapes were tested, all having a thickness of 35 μm, the symbols serve as a legend to understand FIG. 4:

[symbol] tape made from mixture comprising 67% by weight PCL and 33% by weight PBS;

[symbol] tape made from mixture comprising 33% by weight PCL and 67% by weight PBS.

| | PCL/PBS 67/33 | PCL/PBS 33/67 |
|---|---|---|
| Thickness (μm) | 35 | 35 |
| Width (mm) | 3.4 | 2.6 |
| Tex (g/1000 m) | 140.1 | 110.5 |
| Tensile strength | 27.7 | 36.8 |
| (cN/tex) | | |
| Elongation (%) | 67.1 | 27.1 |
| E-modulus 1-5% | 71.6 | 111.0 |
| (cN/tex) | | |
| Tensile strength at | 1.27 | 1.82 |
| 1% (cN/tex) | | |
| Tensile strength at | 2.77 | 4.32 |
| 3% (cN/tex) | | |

The PCL used in this example is Capa™ 6800, purchased from Perstorp. The PBS used in this example is Bionolle™ 1001 MD, purchased from Showa Denko.

It is to be understood that although preferred embodiments and/or materials have been discussed for providing embodiments according to the present invention, various modifications or changes may be made without departing from the scope and spirit of this invention.

### Example 5

The following slit film tape was made comprising 40% by weight PLA and 60% by weight PHA, wherein the viscosity vs share rate at the same temperature for each of the polymers cross between 100 s⁻¹ and 1000 s⁻¹.

| | PLA/PHA 40/60 |
|---|---|
| Thickness (μm) | 42 |
| Width (mm) | 2.2 |
| Tex (g/1000 m) | 114.8 |
| Tensile strength | 15.1 |
| (cN/tex) | |
| Elongation (%) | 35.6 |
| Shrinkage (%) | 4.2 |

1. A filament, made from a polymer composition comprising:
at least 40 to at most 90 percent by weight of a first biodegradable polymer; and,
at least 10 to at most 60 percent by weight of a second biodegradable polymer;
wherein the percentage by weight is expressed compared to the total weight of the polymer composition; and,
wherein the visual degradation speed of the first biodegradable polymer is faster than the visual degradation speed of the second biodegradable polymer when in contact with soil under the same conditions.

2. The filament according to claim 1, wherein the plots of the viscosity of the first biodegradable polymer and the second biodegradable polymer measured according to ISO 1 1.443:2014 at the same temperature, plotted in function of shear rate, cross in the shear rate region from at least 100 s¹ to at most 1000 s¹.

3. The filament according to claim 1, wherein the first biodegradable polymer is PHA and the second biodegradable polymer is PLA.

4. The filament according to claim 1, wherein the first biodegradable polymer is selected from the group comprising: polycaprolactone (PCL), polybutylene succinate-co-adipate (PBSA) and/or polyhydroxyalkanoate (PHA), and/or mixtures thereof.

5. The filament according to claim 1, wherein the second biodegradable polymer is selected from the group comprising: polylactic acid (PLA), polybutyrate (PBAT), polybutylene succinate (PBS), and/or mixtures thereof.

6. The filament according to claim 1, wherein the visual degradation speed of the first biodegradable polymer is such that at least 80% visual degradation occurs in a period of at most 6 weeks, under conditions according to the modified ISO 20200:2015.

7. The filament according to claim 1, wherein the visual degradation speed of the second biodegradable polymer is such that at most 10% visual degradation occurs in a period of at least 25 weeks, under conditions according to the modified ISO 20200:2015 norm.

8. The filament according to claim 1, wherein the filament has a tensile strength at break of at least 10 cN/tex, determined according to ISO 2062(2009), using the following parameters: pretension of 0.5 cN/tex; rate of extension 500 mm/min; gauge length 500 mm.

9. The filament according to claim 1, wherein the filament has an elongation at break of at least 10%, determined according to ISO 2062(2009), using the following parameters: pretension of 0.5 cN/tex; rate of extension 500 mm/min; gauge length 500 mm.

10. The filament according to claim 1, wherein the polymer composition comprises a filler in an amount of at least 0.1 to at most 5.0 percent by weight, wherein the percentage by weight is expressed compared to the total weight of the polymer composition.

11. Method for manufacturing a filament, the method comprising the steps of:
blending from at least 40 to at most 90 percent by weight of a first biodegradable polymer with at least 10 to at most 60 percent by weight of a second biodegradable polymer to form a polymer composition, wherein the visual degradation speed of the first biodegradable polymer is faster than the visual degradation speed of the second biodegradable polymer when in contact with soil under the same conditions;
extruding the polymer composition as filaments or as a film; and,
optionally, slitting the film o slit film tapes;
thereby obtaining a filament.

12. A fabric or a netting comprising filaments according to claim 1.

13. A groundcover comprising filaments according to claim 1.

14. A method comprising using said groundcover according to claim 13 for temporary weed control, and wherein the groundcover has a content of second biodegradable polymer in an amount of at least 10 to at most 40 percent, compared to the total weight of the polymer composition used to make the groundcover.

15. A method comprising using said groundcover according to claim 13 for temporary erosion control, wherein the groundcover has a weight of at least 50 g/m² to at most 1000 g/m², and wherein the groundcover has a content of second biodegradable polymer of at least 5 to at most 30 percent by weight, compared to the total weight of the polymer composition used to make the groundcover

16. A method comprising using said fabric according to claim 12, as temporary packaging material.

17. A method comprising using said netting according to claim 12, as temporary protection material.

18. A fabric or a netting comprising filaments manufactured by a method according o claim 11.

19. A groundcover comprising filaments manufactured by a method according to claim

11.
